(19) United States
(12) Patent Application Publication
(10) Pub. No.: US 2007/0106000 A1
(43) Pub. Date: May 10, 2007

(54) Polymer blend and method for its isolation

(76) Inventors: Hua Guo, Selkirk, NY (US); Allen W. Ko, Rexford, NY (US); Geoffrey H. Riding, Castleton, NY (US); John Rowe, Baltimore, NY (US)

Correspondence Address: CANTOR COLBURN, LLP, 55 GRIFFIN ROAD SOUTH, BLOOMFIELD, CT, 06002, US

(21) Appl. No.: 11/271,608

(22) Filed: Nov. 10, 2005

(51) Int. Cl. C08K 5/05

(52) U.S. Cl. 524/379

(57) ABSTRACT

In a method of isolating a polymer blend from solution, a homogeneous solution including a poly(arylene ether), a poly(alkenyl aromatic), and a solvent is combined with an anti-solvent to form a dispersion containing solid particles. The solid particles have improved handling properties compared to particles formed from precipitation of the poly(arylene ether) alone.

### BACKGROUND OF THE INVENTION

This disclosure relates to methods of isolating poly(arylene ether) from solution.

Poly(arylene ether) resins, such as polyphenylene ether resins (PPE), can be prepared by the oxidative polymerization of a monohydric phenol in the presence of a solvent to form a solution in which the poly(arylene ether) is soluble. The poly(arylene ether) can then be isolated by combining the solution with an anti-solvent solvent to precipitate the poly(arylene ether). However, such precipitations yield powdered precipitates with a substantial weight fraction of particles smaller than 75 micrometers. Elaborate powder handling systems are required to prevent explosion hazards that can result from the fine powder. The fine powders also create difficulties in pipeline transfers of the isolated solids, and feeding of the solids to extruders. Furthermore, the low bulk density of the fine powder results in high shipping costs per unit weight of the poly(arylene ether) resin.

It would be advantageous to be able to ship poly(arylene ether) resins to various locations around the world for compounding into resin compositions to serve local market needs. However, current handling procedures require significant investment for equipment modifications and consequently limit the commercial feasibility for such compounding flexibility.

One approach to solving problems associated with poly(arylene ether) powder is pelletization of poly(arylene ether) powder using standard compounding extruders followed by pelletization of the extrudate to obtain pellets having dimensions of about 3 millimeters by about 3 millimeters. Unfortunately, the physical properties of many resin compositions made using the pellets are inferior compared to those of control compositions made with poly(arylene ether) powder, and the pellets must be ground to a smaller size in order to obtain physical properties that closely approximate those of control compositions. Consequently, the utility of the poly(arylene ether) pellet approach has been limited.

Therefore, a continuing need exists for improved methods of isolating poly(arylene ether) from solution that allow improved handling and shipping of the resulting poly(arylene ether) resin.

### BRIEF DESCRIPTION OF THE INVENTION

Disclosed herein are methods of isolating poly(arylene ether) blends from solution.

One embodiment is a method of isolating a polymer blend, comprising: combining a homogeneous solution with an anti-solvent to form a dispersion comprising a solid; wherein the solution comprises a poly(arylene ether), a poly(alkenyl aromatic), and a solvent; and wherein the solid comprises the poly(arylene ether) and the poly(alkenyl aromatic).

Solids obtained from the method are also disclosed.

### DETAILED DESCRIPTION OF THE INVENTION

In this specification and in the claims, which follow, reference will be made to a number of terms which shall be defined to have the following meanings.

The singular forms “a,” “an,” and “the” include plural referents unless the context clearly dictates otherwise.

“Optional” or “optionally” means that the subsequently described event or circumstance may or may not occur, and that the description includes instances where the event occurs and instances where it does not.

“Combination” as used herein includes mixtures, copolymers, reaction products, blends, composites, and the like.

“Combinations thereof” refers to combinations of two or more.

The modifier “about” used in connection with a quantity is inclusive of the stated value and has the meaning dictated by the context (e.g., it includes the degree of error associated with measurement of the particular quantity).

Furthermore, the endpoints of all ranges reciting the same characteristic are independently combinable and inclusive of the recited endpoint.

As will be explained in greater detail below, it has been discovered that a solid comprising coarse particles comprising a poly(arylene ether) and a poly(alkenyl aromatic) is produced by co-precipitating poly(arylene ether) and poly(alkenyl aromatic) from a solution with anti-solvent. This is a surprising finding, because a solution comprising only solvent and poly(arylene ether) generally produces a fine powder, i.e., particles having a particle size less than 75 micrometers, when added to an anti-solvent. Since the primary use of poly(arylene ether) resins is in blends that further comprise poly(alkenyl aromatic) resins, the co-precipitation of poly(arylene ether) and poly(alkenyl aromatic) resins yields a solid product of considerable commercial value.

The solution employed in this method is a homogeneous solution. A homogeneous solution is defined herein as a solution is substantially free of undissolved solid particles, especially particles having any dimension greater than or equal to about 100 micrometers. By substantially free, it is meant that the solution comprises less than or equal to 0.5 weight percent of such undissolved solid particles, based on a total weight of the solution. It is possible to objectively determine whether a solution is homogeneous according to this definition by using turbidity measurements or solution filtration techniques.

In one embodiment, the solid comprises less than or equal to 15 weight percent of particles having a particle size less than 75 micrometers as determined by sieve analysis according to ASTM D 1921-01, Method B. The solid may comprise less than or equal to 10 weight percent of such particles, or less than or equal to 5 weight percent of such particles, or less than or equal to 2 weight percent of such particles, or less than or equal to 1 weight percent of such particles. In a sieve analysis according to ASTM D 1921-01, Method B, one determines the weight percent of particles passing through a wire mesh sieve with a known opening size. Material that does not pass through the sieve may include not only discrete particles having a dimension greater than the opening size, but also particle agglomerates having such a dimension that survive the mechanical shaking test used in ASTM D 1921-01, Method B. So, it will be understood that the phrase “particles having a particle size less than 75 micrometers” refers only to particles that pass through a sieve having 75 micrometers openings and therefore does not include particles that may individually have no dimension greater than or equal to 75 micrometers but that are present in an agglomerate that does not pass through the sieve openings under the test conditions of ASTM D 1921-01, Method B.

There are many suitable methods of preparing the homogeneous solution of the poly(arylene ether) and the poly(alkenyl aromatic) resin. For example, separate homogeneous solutions of the poly(arylene ether) and the poly(alkenyl aromatic) resin may be prepared and combined. Alternatively, a homogeneous solution of the poly(arylene ether) may be prepared, and solid poly(alkenyl aromatic) resin may be added to it and dissolved. Alternatively, a homogeneous solution of the poly(alkenyl aromatic) resin may be prepared, and solid poly(arylene ether) may be added to it and dissolved. Alternatively, solid poly(arylene ether) and poly(alkenyl aromatic) resins may be simultaneously added to a solvent and subsequently dissolved.

In one embodiment, a homogeneous solution of the poly(arylene ether) and the poly(alkenyl aromatic) resin is prepared, and a portion of the solvent is removed (i.e., the solution is concentrated) before the solution is combined with anti-solvent.

In one embodiment, about 10 weight percent to about 50 weight percent total of the poly(arylene ether) and the poly(alkenyl aromatic) are dissolved in the solution, wherein weight percents are based on a total weight of the solution. Within this range, the total weight percent of poly(arylene ether) and poly(alkenyl aromatic) may be at least about 20 weight percent, or at least about 24 weight percent. Also within this range, the total weight percent of poly(arylene ether) and poly(alkenyl aromatic) may be up to about 45 weight percent, or up to about 30 weight percent. In one embodiment, the homogeneous solution comprises the poly(arylene ether) and the poly(alkenyl aromatic) in a weight ratio of about 5:95 to about 95:5. Within this range, the ratio may be at least about 10:90, or at least about 30:70, or at least about 50:50. Also within this range, the ratio may be up to about 90:10, or up to about 80:20.

As used herein, a “poly(arylene ether)” comprises a plurality of structural units of the formula (I): 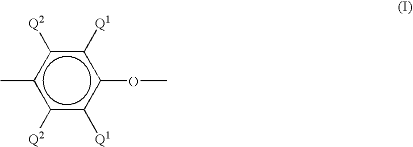
wherein for each structural unit, each Q¹ is independently halogen, C₁-C₇ primary or secondary lower alkyl, phenyl, haloalkyl, aminoalkyl, alkenylalkyl, alkynylalkyl, hydrocarbonoxy, aryl, and halohydrocarbonoxy, wherein at least two carbon atoms separate the halogen and oxygen atoms; and each Q² is independently hydrogen, halogen, C₁-C₇ primary or secondary lower alkyl, phenyl, haloalkyl, aminoalkyl, alkenylalkyl, alkynylalkyl, hydrocarbonoxy, aryl, and halohydrocarbonoxy, wherein at least two carbon atoms separate the halogen and oxygen atoms. In one embodiment, each Q¹ is independently C₁-C₄ alkyl or phenyl, and each Q² is independently hydrogen or methyl. The poly(arylene ether) can comprise molecules having aminoalkyl-containing end group(s), typically located in an ortho position to the hydroxy group. Also frequently present are tetramethyl diphenoquinone (TMDQ) end groups, typically obtained from reaction mixtures in which tetramethyl diphenoquinone by-product is present.

The poly(arylene ether) can be in the form of a homopolymer; a copolymer; a graft copolymer; an ionomer; or a block copolymer; as well as combinations comprising at least one of the foregoing. For example, in one embodiment, the poly(arylene ether) comprises 2,6-dimethyl-1 ,4-phenylene ether units, optionally in combination with 2,3,6-trimethyl-1,4-phenylene ether units.

The poly(arylene ether) can be prepared by the oxidative coupling of monohydroxyaromatic compound(s) such as 2,6-xylenol and 2,3,6-trimethylphenol. Catalyst systems are generally employed for such coupling; they can contain heavy metal ion such as a copper, manganese, iron, or cobalt ions, usually in combination with various other materials such as secondary amines, tertiary amines, N,N′-dialkylalkylenediamines, halides, or combinations of two or more of the foregoing.

The poly(arylene ether) can be ftnctionalized with a polyfunctional compound such as a polycarboxylic acid or those compounds having in the molecule both (a) a carbon-carbon double bond or a carbon-carbon triple bond and b) at least one carboxylic acid, anhydride, amide, ester, imide, amino, epoxy, orthoester, or hydroxy group. Examples of such polyfunctional compounds include maleic acid, maleic anhydride, fumaric acid, and citric acid.

The poly(arylene ether) can have a number average molecular weight of about 3,000 grams per mole (g/mol) to about 40,000 g/mol and a weight average molecular weight of about 5,000 g/mol to about 80,000 g/mol, as determined by gel permeation chromatography using monodisperse polystyrene standards, a styrene divinyl benzene gel at 40° C. and samples having a concentration of 1 milligram per milliliter of chloroform. The poly(arylene ether) or combination of poly(arylene ether)s may have an initial intrinsic viscosity of about 0.1 to about 1.5 deciliter per gram (d1/g), as measured in chloroform at 25° C. Within this range, the initial intrinsic viscosity may be at least about 0.12 deciliter per gram, or at least about 0.3 deciliter per gram. Also within this range, the initial intrinsic viscosity may be up to about 0.8 deciliter per gram, or up to about 0.6 deciliter per gram. Initial intrinsic viscosity is defined as the intrinsic viscosity of the poly(arylene ether) prior to melt mixing with the other components of the composition, and final intrinsic viscosity is defined as the intrinsic viscosity of the poly(arylene ether) after melt mixing with the other components of the composition. As understood by one of ordinary skill in the art the viscosity of the poly(arylene ether) may be up to 30% higher after melt mixing. The percentage of increase can be calculated by (final intrinsic viscosity−initial intrinsic viscosity)/initial intrinsic viscosity.

The solid formed as part of the dispersion comprising the poly(arylene ether) and the poly(alkenyl aromatic) (hereinafter “solid”) will generally have approximately the same proportion of poly(arylene ether) and poly(alkenyl aromatic) as the homogeneous solution. If poly(arylene ether) resins having an initial intrinsic viscosity less than about 0.2 deciliter per gram are used, the solid may be depleted in the poly(arylene ether) (enriched in the poly(alkenyl aromatic) resin) relative to the solution.

As briefly noted above, the solution and resulting solid further comprises a poly(alkenyl aromatic). The term “poly(alkenyl aromatic)” as used herein includes polymers prepared by methods known in the art including bulk, suspension, and emulsion polymerization, which contain at least 25% by weight of structural units derived from an alkenyl aromatic monomer of the formula 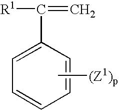
wherein R¹ is hydrogen, C₁-C₈ alkyl, or halogen; Z¹ is vinyl, halogen or C₁-C₈ alkyl; and p is 0, 1, 2, 3, 4, or 5. More specifically, alkenyl aromatic monomers include styrene, chlorostyrene, and vinyltoluene. The poly(alkenyl aromatic)s include homopolymers of an alkenyl aromatic monomer; random copolymers of an alkenyl aromatic monomer, such as styrene, with one or more different monomers such as acrylonitrile, butadiene, alpha-methylstyrene, ethylvinylbenzene, divinylbenzene and maleic anhydride; unhydrogenated and hydrogenated block copolymers of an alkenyl aromatic and a conjugated diene; and rubber-modified poly(alkenyl aromatic)s.

When the poly(alkenyl aromatic) is a unhydrogenated or hydrogenated block copolymers of an alkenyl aromatic and a conjugated diene, the conjugated diene may be, for example, 1,3-butadiene, 2-methyl-1,3-butadiene, 2,3-dimethyl-1,3-butadiene, or 1,3-pentadiene. The arrangement of the poly(alkenyl aromatic) and poly(conjugated diene) blocks may be a linear structure (e.g., diblock, triblock, tetrablock copolymers), or a radial teleblock structure with or without a branched chain. When the poly(alkenyl aromatic) is a hydrogenated block copolymer, the poly(conjugated diene) blocks may be partially or fully hydrogenated, so that about 10 to 100% of the unsaturated bonds in the aliphatic chain moiety derived from the conjugated diene are reduced. The poly(alkenyl aromatic) may be partially hydrogenated to selectively reduce pendant (rather than in-chain) aliphatic double bonds. Preferred unhydrogenated block copolymers include styrene-butadiene diblock copolymers, styrene-butadiene-styrene triblock copolymers, styrene-isoprene diblock copolymers, and styrene-isoprene-styrene triblock copolymers. Preferred hydrogenated block copolymers include styrene-(ethylene-butylene) diblock copolymers, styrene-(ethylene-butylene)-styrene triblock copolymers, styrene-(butadiene-butylene)-styrene triblock copolymers, and partially and fully hydrogenated styrene-isoprene-styrene triblock copolymers. Suitable unhydrogenated and hydrogenated block copolymers are further described in U.S. Pat. Nos. 6,855,767 and 6,872,777 to Adedeji et al.

When the poly(alkenyl aromatic) is a rubber-modified poly(alkenyl aromatic), it may comprise (a) a homopolymer of an alkenyl aromatic, and (b) a rubber modifier in the form of a blend with the homopolymer, or a graft on the homopolymer, or a combination thereof, wherein the rubber modifier can be a polymerization product of at least one C₄-C₁₀ nonaromatic diene monomer, such as butadiene or isoprene, and wherein the rubber-modified poly(alkenyl aromatic) comprises about 98 weight percent to about 70 weight percent of the homopolymer of an alkenyl aromatic monomer and about 2 weight percent to about 30 weight percent of the rubber modifier, specifically about 88 weight percent to about 94 weight percent of the homopolymer of an alkenyl aromatic monomer and about 6 weight percent to about 12 weight percent of the rubber modifier. These rubber-modified polystyrenes are commercially available as, for example, GEH 1897 from General Electric Plastics, and EB 6755 or MA5350 from Phillips Chemical.

In one embodiment, the poly(alkenyl aromatic) resin is selected from impact-modified polystyrenes, atactic homopolystyrenes, syndiotactic polystyrenes, block copolymers of an alkenyl aromatic and a conjugated diene, hydrogenated block copolymers of an alkenyl aromatic and a conjugated diene, and combinations thereof. In one embodiment, the poly(alkenyl aromatic) comprises an atactic homopolystyrene having a weight average molecular weight of about 50,000 to about 1,500,000 atomic mass units. In one embodiment, the poly(alkenyl aromatic) comprises an impact-modified polystyrene having a weight average molecular weight of about 50,000 to about 1,500,000 atomic mass units. In one embodiment, the poly(alkenyl aromatic) comprises a styrene-butadiene-styrene triblock copolymer having a butadiene content of about 60 to about 90 weight percent. In one embodiment, the poly(alkenyl aromatic) comprises a radial teleblock styrene-butadiene block copolymer.

The stereoregularity of the poly(alkenyl aromatic) can be atactic or syndiotactic. In one embodiment, the poly(alkenyl aromatic)s include atactic and syndiotactic homopolystyrenes. Suitable atactic homopolystyrenes are commercially available as, for example, EB3300 from Phillips Chemical, and 168M and 168MO from INEOS Styrenics. Suitable syndiotactic homopolystyrenes may be prepared according to methods described in U.S. Pat. Nos. 5,189,125 and 5,252,693 to Ishihara et al., U.S. Pat. No. 5,254,647 to Yamamoto et al., U.S. Pat. No. 5,272,229 to Tomotsu et al., and U.S. Pat. No. 5,294,685 to Watanabe et al.

The solvent is selected such that it is capable of dissolving both the poly(arylene ether) and the poly(alkenyl aromatic). Suitable organic solvents include aromatic hydrocarbons, halogenated aromatic hydrocarbons, halogenated alkanes, halogenated alkenes, and combinations thereof. Suitable aromatic hydrocarbon solvents include, for example, C₆-C₁₈ aromatic hydrocarbons, such as toluene, xylenes, and the like, and combinations thereof. In one embodiment, the solvent comprises toluene. Suitable halogenated aromatic hydrocarbons include, for example, chlorobenzene, dichlorobenzenes, and the like, and combinations thereof. Suitable halogenated alkanes include, for example, dichloromethane, chloroform, carbon tetrachloride, dichloroethanes, trichloroethanes, and the like, and combinations thereof. Suitable halogenated alkenes include, for example, 1,1-dichloroethylene, 1,2-dichloroethylene, 1,1,2-trichloroethylene, and the like, and combinations thereof.

In one embodiment, after formation of the solid comprising poly(arylene ether) and poly(alkenyl aromatic), the solvent can be separated from the solid and the anti-solvent and recycled. In commercial operation, the use of recycled solvent can greatly reduce the operating costs of operation compared to methods where the solvent is not recycled. In various embodiments, the solvent may comprise impurities that are present in an amount less than or equal to 1 weight percent, specifically less than or equal to 0.5 weight percent, based on a total weight of the solvent. The main impurity in recycled solvent is typically the anti-solvent (or mix of anti-solvents) employed. The method facilitates solvent and anti-solvent recycling compared to poly(arylene ether) precipitation processes, where fine particles of precipitated poly(arylene ether) contaminate the filtrate.

There is no particular limit on the anti-solvent employed in the method, as long as the poly(arylene ether) and the poly(alkenyl aromatic) each have a solubility in the anti-solvent of less than about 1 gram per liter, preferably less than 0.5 gram per liter. Suitable anti-solvents include lower alkanols having one to ten carbon atoms, such as methanol, ethanol, isopropanol, n-butanol, and the like; ketones having three to ten carbon atoms, such as acetone and methyl ethyl ketone, and the like; and alkanes having five to ten carbon atoms, such as pentane, hexane, heptane; and the like; and combinations thereof. For example, suitable anti-solvents include methanol, ethanol, n-propanol, isopropanol, n-butanol, isobutanol, t-butanol, or the like, or a mixture thereof. In one embodiment, the anti-solvent comprises methanol and at least one C₃-C₆ alkanol. Suitable C₃-C₆ alkanols include, for example, n-propanol, isopropanol, n-butanol, isobutanol, t-butanol, n-pentanol, 2-methyl-1-butanol, 2-methyl-2-butanol, 3-methyl-1-butanol, 3-methyl-2-butanol, 2,2-dimethyl-1-propanol (neopentyl alcohol), cyclopentanol, 1-hexanol, 2-hexanol, 3-hexanol, 2-methyl-1-pentanol, 2-methyl-2-pentanol, 2-methyl-3-pentanol, 4-methyl-1-pentanol, 4-methyl-2-pentanol, 3-methyl-1-pentanol, 3-methyl-2-pentanol, 3-methyl-3-pentanol, 2-ethyl-1-butanol, 2,3-dimethyl-1-butanol, 2,3-dimethyl-2-butanol, 2,2-dimethyl-1-butanol, 3,3-dimethyl-1 -butanol, 3,3-dimethyl-2-butanol, cyclopentylmethanol, 1-methylcyclopentanol, 2-methylcyclopentanol, 3-methylcyclopentanol, cyclohexanol, and the like, and mixtures thereof. In another embodiment, the anti-solvent comprises (a) methanol, and (b) isopropanol, n-butanol, or a mixture thereof. In other embodiments, the anti-solvent comprises methanol.

In a similar fashion to recycling of the solvent, after formation of the solid comprising the poly(arylene ether) and the poly(alkenyl aromatic), the anti-solvent can be separated from the solids and the solvent and recycled. In commercial operation, the use of recycled anti-solvent can greatly reduce the operating costs of operation compared to methods where the anti-solvent is not recycled. In various embodiments, the anti-solvent can comprise impurities that are present in an amount less than or equal to about 1 weight percent, specifically less than or equal to 0.5 weight percent, based on a total weight of the anti-solvent. The main impurities in recycled anti-solvent are typically the solvent (or mix of solvents) employed, as well as water.

The solution and the anti-solvent may be combined in a ratio effective to precipitate at least 90 weight percent, preferably at least 95 weight percent, of the total of the poly(arylene ether) and the poly(alkenyl aromatic) dissolved in the solution. In one embodiment, the solution and the anti-solvent are combined in a weight ratio of about 1:10 to about 2:1. Within this range, the ratio may be at least about 1:8, or at least about 1:6. Also within this range, the ratio may be up to about 1:3, or up to about 1:2, or up to about 1:1. In one embodiment, the solution and the anti-solvent are combined by gradually adding the solution to all of the anti-solvent, with agitation. In another embodiment, a portion of the solution is added to a portion of the anti-solvent, with agitation, and the remainder of the solution and the remainder of the anti-solvent are gradually added, with agitation, to the existing mixture at rates that maintain a constant ratio of solution to anti-solvent in the mixture.

The temperatures of the solution and the anti-solvent immediately before they are combined will vary according to many factors, including, for example, the poly(arylene ether) composition, the poly(arylene ether) intrinsic viscosity, the poly(arylene ether) concentration in the solution, the solvent type, the anti-solvent type, and the weight ratio of the solution to anti-solvent. In one embodiment, the method comprises combining the solution at a temperature of about 60 to about 90° C. with the anti-solvent at a temperature of about 15 to about 60° C. Within these ranges, the solution temperature may be at least about 70° C., or at least 80° C. Also within these ranges, the anti-solvent temperature can be at least about 20° C., or at least 25° C.; and the anti-solvent temperature can be up to 55° C., or up to 50° C. In one embodiment, the temperature of the combined solution and anti-solvent mixture can be about 30 to about 55° C.

In another embodiment, the method may, optionally, further comprise concentrating the solution prior to the combining the solution with the anti-solvent. In one embodiment, concentrating the solution is conducted in a continuous process section comprising a heat exchanger, a flash unit, and a circulation pump. Optionally, part of the concentrated solution product discharged from the flash unit can be recycled to the inlet of the heat exchanger. In one embodiment, the flash unit is operated at a pressure less than one atmosphere, and the temperature of the solution in the heat exchanger is greater than the boiling point of the solvent at the actual pressure in the flash unit. In this embodiment, the lower pressure in the flash unit results in adiabatic flashing of part of the solvent. Pre-concentrating the solution can comprise maintaining a flash vessel at a pressure, P, heating the solution to a temperature, T, above the boiling point of the solvent at pressure P, introducing the heated solution to the flash vessel to evaporate a portion of the solvent and form a concentrated solution, and re-circulating a portion of the concentrated solution to a point upstream of the flash vessel.

Combining the solution with the anti-solvent forms a poly(arylene ether)/poly(alkenyl aromatic) dispersion. The method can, optionally, further comprise isolating the poly(arylene ether)/poly(alkenyl aromatic) solids from the dispersion. In one embodiment, isolating the solid from the dispersion comprises filtration. In another embodiment, isolating the solid from the dispersion comprises centrifugation. Suitable filtration apparatuses include rotating filters, continuous rotary vacuum filters, continuous moving bed filters, batch filters, and the like. Suitable solid/liquid separation apparatuses include continuous solid/liquid centrifuges.

In one embodiment, the isolated solid may comprise less than or equal to 15 weight percent of particles having a particle size less than 75 micrometers as determined according to ASTM D 1921-01, Method B. The weight percent of such particles may be less than or equal to 10, or less than or equal to 5, or less than or equal to 2, or less than or equal to 1.

Optionally, the above described method of isolating a solid comprising poly(arylene ether) and poly(alkenyl aromatic) can be combined with other isolation techniques including, but not limited to, high shear isolation. An exemplary high shear isolation method is discussed in U.S. Patent Application Publication No. US 2005/0171331 A1 to Ingelbrecht. More specifically, the solution and an anti-solvent can be combined at a shear rate of greater than or equal to about 20,000 sec⁻¹. Within this range, the shear rate can be greater than or equal to about 50,000 sec⁻¹, specifically greater than or equal to about 75,000 sec⁻¹, more specifically greater than or equal to about 100,000 sec⁻¹. In one embodiment, the shear rate is less than or equal to about 500,000 sec⁻¹, specifically less than or equal to about 350,000 sec⁻¹, even more specifically less than or equal to about 250,000 sec⁻¹. The desired high shear can be achieved using a pump comprising a stator and a rotor.

One embodiment is a method of isolating a polymer blend, comprising: combining a homogeneous solution with an anti-solvent to form a dispersion comprising a solid; wherein the solution comprises a poly(arylene ether), a poly(alkenyl aromatic), and a solvent; wherein the solid comprises the poly(arylene ether) and the poly(alkenyl aromatic); wherein about 20 weight percent to 50 weight percent total of the poly(arylene ether) and the poly(alkenyl aromatic) are dissolved in the solution prior to forming the dispersion, wherein weight percents are based on a total weight of the poly(arylene ether), the poly(alkenyl aromatic), and the solvent; and wherein the solid comprises less than or equal to 10 weight percent of particles having a particle size less than 75 micrometers as determined according to ASTM D 1921-01, Method B.

Another embodiment is a method of isolating a polymer blend, comprising: combining a homogeneous solution with an anti-solvent to form a dispersion comprising a solid; wherein the solution comprises a poly(arylene ether), a poly(alkenyl aromatic), and a solvent; and wherein the solid comprises the poly(arylene ether) and the poly(alkenyl aromatic); wherein the poly(arylene ether) comprises a poly(2,6-dimethyl-1,4-phenylene ether) having an intrinsic viscosity of about 0.3 to about 0.6 deciliter per gram in chloroform at 25° C.; wherein the poly(alkenyl aromatic) comprises a rubber-modified polystyrene comprising about 70 to about 98 weight percent homopolystyrene, and about 2 to about 30 weight percent of rubber modifier that is a polymerization product of at least one C₄-C₁₀ nonaromatic diene monomer; wherein the solvent comprises toluene; wherein the anti-solvent comprises methanol; wherein about 20 weight percent to 50 weight percent total of the poly(arylene ether) and the poly(alkenyl aromatic) are dissolved in the solution prior to forming the dispersion, wherein weight percents are based on a total weight of poly(arylene ether), poly(alkenyl aromatic), and solvent; wherein the solid comprises less than or equal to 5 weight percent of particles having a particle size less than 75 micrometers as determined according to ASTM D 1921-01, Method B.

One advantage of the method is that the resulting resin comprising poly(arylene ether) and poly(alkenyl aromatic) has particles greater than 75 micrometers, which can reduce or eliminate the need for the special handling equipment needed for fine powders both in the poly(arylene ether) resin process and in subsequent compounding steps. For example, expensive safety measures required to prevent explosion of small poly(arylene ether) particles can be reduced or eliminated. Moreover, solids prepared according to the present method can be directly injection molded without an intermediate melt blending step.

Furthermore, the solids prepared according to the present method have a higher bulk density than the fine powders obtained from precipitation of poly(arylene ether) alone. The high bulk density reduces the volume occupied by the material during storage and transportation and thereby reduces storage and transportation costs. Moreover, the solids can also be fed to an extruder at higher feed rates than can be employed with poly(arylene ether) powder.

Solids prepared according to the present method may be used as concentrates to formulate blends further comprising other polymer resins. For example, the lower glass transition temperatures of the solids compared to pure poly(arylene ether) resins allows the solids to be may be melt blended with additional poly(alkenyl aromatic) resin using less vigorous mixing conditions (e.g., single-screw extruder instead of a twin-screw extruder). One embodiment is polymer blend comprising the solid and a polymer selected from impact-modified polystyrenes, atactic homopolystyrenes, syndiotactic polystyrenes, block copolymers of an alkenyl aromatic and a conjugated diene, hydrogenated block copolymers of an alkenyl aromatic and a conjugated diene, and combinations thereof.

The following non-limiting examples further illustrate the various embodiments described herein.

### EXAMPLES 1-4

### Comparative Examples 1 and 2

Table 1 summarizes the solid components of the solution and their sources.

TABLE 1

| Component | |
|---|---|
| Abbreviation | Description/Trade name/Supplier |
| PPE .46 IV | a poly(2,6-dimethyl-1,4-phenylene ether) having |
| | intrinsic viscosity of 0.46 dl/g, obtained as PPO ® 646 |
| | from General Electric Company |
| PPE .30 IV | a poly(2,6-dimethyl-1,4-phenylene ether) having |
| | intrinsic viscosity of 0.30 dl/g, obtained as PPO ® 630 |
| | from General Electric Company |
| HIPS | a rubber-modified polystyrene having a weight average |
| | molecular weight of about 215,000, a number average |
| | molecular weight of about 55,000, about 89.5 weight |
| | percent homopolystyrene, and about 10.5 weight percent |
| | polybutadiene, available as NORYL ® HIPS 3190 from |
| | General Electric Company. |

Example 1 was prepared by the following process. Toluene (833.8 grams) was heated to 185° F. (85° C.) with agitation in a glass reaction vessel. HIPS (24.2 grams) was added to the vessel, and the mixture was maintained at a temperature of at about 65° C. and agitated at 350 revolutions per minute until the HIPS dissolved. The 0.46 IV PPE (242 grams) was added to the solution, and the resulting mixture was agitated until the poly(arylene ether) dissolved and a homogeneous solution was formed. The total mixing time was about two hours. Room temperature methanol (600 grams) was added to a single-speed, high shear-Waring-Explosion-Proof Blender, model 9304. A 150 gram portion of the solution, which had a temperature of about 65° C., was added slowly to the agitated methanol over the course of about five minutes to create a mixture having a weight ratio of methanol to solution of about 4:1. After about 5 minutes with continued agitation, a second 150 gram portion of the solution was added over the course of about 5 minutes to yield a mixture having a weight ratio of methanol to solution of about 2:1. After an additional 15 minutes with agitation, the resulting dispersion was filtered using Whatman number 4 qualitative filter paper. The filtered solid was not washed, but it was dried overnight in a vacuum oven at about 50-55° C. and an absolute pressure of about 700-750 millimeters of mercury.

Example 2 was prepared according to the procedure for Example 1, except that the 0.46 IV PPE amount was 131.1 grams, the HIPS amount was 131.1 grams, and the solution was prepared by first dissolving the poly(arylene ether) in the toluene, then dissolving the HIPS in the resulting solution. To prepare the poly(arylene ether) solution, 300 grams of toluene was set aside, and 533.8 grams were heated to 65° C. The poly(arylene ether) was added, and the portions of the 300 grams of toluene were used to periodically wash the neck of the flask while the poly(arylene ether) dissolved. Once the poly(arylene ether) had dissolved, the HIPS was added and dissolved readily.

Example 3 was prepared according to the procedure for Example 2, except that the components and amounts were toluene (684 grams), 0.46 IVPPE (162 grams), and HIPS (54 grams).

Example 4 was prepared according to the procedure for Example 3, except that Example 4 used 0.31 IV PPE.

Comparative Examples 1 and 2 were plant production samples (i.e., commercially produced samples) of poly(arylene ether) resins having intrinsic viscosities of 0.46 and 0.30 deciliter/gram, respectively.

The weight fraction of each sample having particle size less than 75 microns was determined as follows. A U.S. standard sieve no. 200 mesh size (openings of 75 micrometers (0.0029 inches)) was tared, as was the accompanying pan. A portion of dried sample was pre-weighed. The sieve was fitted with the pan, and the resin sample was placed in the sieve. The sieve was agitated with manual shaking for three minutes. Weights were determined for the sieve+particles ≧75 micrometers, and the pan+particles <75 μm. The weight percent of sample with particles <75 micrometers was calculated as follows:
wt % <75 μm=l00=(wt<75 μm)/(initial sample wt)
where “wt %” is an abbreviation for “weight percent”;“wt” is an abbreviation for “weight”; and “μm” is an abbreviation for “micrometers”.

The results are summarized in Table 2. The results show that all resin samples precipitated from homogeneous solutions containing poly(arylene ether) and poly(alkenyl aromatic) have less than 12 weight percent particles smaller than 75 micrometers (Exs. 1-4), three of the samples have less than 2 weight percent particles smaller than 75 micrometers (Exs. 2-4), and one of the samples had essentially no particles smaller than 75 micrometers (i.e., less than 0.01 weight percent of particles less than 75 micrometers; Ex. 2). In contrast, commercially prepared poly(arylene ether) resins precipitated from solutions that did not contain poly(alkenyl aromatic) resin had about substantial about 20 to 28 weight percent of particles smaller than 75 micrometers (C. Exs. 1 and 2).

TABLE 2

| | | | | | | | | weight |
|---|---|---|---|---|---|---|---|---|
| | | | | | | weight of | weight of | percent of |
| | | weight | initial | sieve + particles | pan + particles | sample with | sample with | sample with |
| | PPE IV | percent HIPS | sample | ≧75 μm | <75 μm | particles ≧75 μm | particles <75 μm | particles <75 μm |
| sample | (dL/g) | (%) | weight (g) | (g) | (g) | (g) | (g) | (%) |
| Ex. 1 | 0.46 | 10 | 20.15 | 362.65 | 360.49 | 17.76 | 2.39 | 11.86 |
| Ex. 2 | 0.46 | 50 | 18.24 | 363.11 | 358.10 | 18.22 | 0.00 | 0.00 |
| Ex. 3 | 0.46 | 25 | 20.04 | 364.63 | 358.40 | 19.74 | 0.30 | 1.50 |
| Ex. 4 | 0.30 | 25 | 23.63 | 368.12 | 358.46 | 23.23 | 0.36 | 1.52 |
| C. Ex. 1 | 0.46 | 0 | 25.29 | 365.11 | 363.10 | 20.22 | 5.00 | 19.77 |
| C. Ex. 2 | 0.3 | 0 | 21.91 | 360.68 | 364.14 | 15.79 | 6.04 | 27.57 |

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the invention scope thereof. It is, therefore intended that the invention not be limited to the particular embodiment disclosed as the best mode contemplated for carrying out this invention, but that the invention will include all embodiments falling within the scope of appended claims.

What is claimed is:

1. A method of isolating a polymer blend, comprising:
combining a homogeneous solution with an anti-solvent to form a dispersion comprising a solid; wherein the solution comprises a poly(arylene ether), a poly(alkenyl aromatic), and a solvent; and wherein the solid comprises the poly(arylene ether) and the poly(alkenyl aromatic).

2. The method of claim 1, wherein the solid comprises less than or equal to 15 weight percent of particles having a particle size less than 75 micrometers as determined according to ASTM D 1921-01, Method B.

3. The method of claim 1, wherein the solid comprises less than or equal to 5 weight percent of particles having a particle size less than 75 micrometers as determined according to ASTM D 1921-01, Method B.

4. The method of claim 1, wherein the solution and the anti-solvent are combined in a weight ratio of about 1:10 to about 2:1.

5. The method of claim 1, wherein the solution and the anti-solvent are combined in a weight ratio of about 1:1 to about 1:3.

6. The method of claim 1, wherein the solvent comprises a C₆-C₁₈ aromatic hydrocarbon.

7. The method of claim 1, wherein the solvent comprises toluene.

8. The method of claim 1, wherein the anti-solvent comprises a compound selected from alkanols having one to ten carbon atoms, ketones having three to ten carbon atoms, alkanes having five to ten carbon atoms, and combinations thereof.

9. The method of claim 1, wherein the anti-solvent comprises methanol.

10. The method of claim 1, wherein the homogeneous solution comprises about 10 to about 50 weight percent total of the poly(arylene ether) and the poly(alkenyl aromatic), based on the total weight of the homogeneous solution.

11. The method of claim 1, wherein the homogeneous solution comprises the poly(arylene ether) and the poly(alkenyl aromatic) in a weight ratio of about 5:95 to about 95:5.

12. The method of claim 1, wherein the poly(arylene ether) comprises 2,6-dimethyl-1,4-phenylene ether units, and wherein the poly(alkenyl aromatic) is selected from impact-modified polystyrenes, atactic homopolystyrenes, syndiotactic polystyrenes, block copolymers of an alkenyl aromatic and a conjugated diene, hydrogenated block copolymers of an alkenyl aromatic and a conjugated diene, and combinations thereof.

13. A method of isolating a polymer blend, comprising:
combining a homogeneous solution with an anti-solvent to form a dispersion comprising a solid; wherein the solution comprises a poly(arylene ether), a poly(alkenyl aromatic), and a solvent; and wherein the solid comprises the poly(arylene ether) and the poly(alkenyl aromatic), wherein about 20 weight percent to 50 weight percent total of the poly(arylene ether) and the poly(alkenyl aromatic) are dissolved in the solution prior to forming the dispersion, wherein weight percents are based on a total weight of the poly(arylene ether), the poly(alkenyl aromatic), and the solvent; and
wherein the solid comprises less than or equal to 10 weight percent of particles having a particle size less than 75 micrometers as determined according to ASTM D 1921-01, Method B.

14. The method of claim 13, wherein the solution and the anti-solvent are combined in a weight ratio of about 1:10 to about 2:1.

15. The method of claim 13, wherein the solution and the anti-solvent are combined in a weight ratio of about 1:3 to about 1:1.

16. A method of isolating a polymer blend, comprising:
combining a homogeneous solution with an anti-solvent to form a dispersion comprising a solid; wherein the solution comprises a poly(arylene ether), a poly(alkenyl aromatic), and a solvent; and wherein the solid comprises the poly(arylene ether) and the poly(alkenyl aromatic);
wherein the poly(arylene ether) comprises a poly(2,6-dimethyl-1,4-phenylene ether) having an intrinsic viscosity of about 0.3 to about 0.6 deciliter per gram in chloroform at 25° C.;
wherein the poly(alkenyl aromatic) comprises a rubber-modified polystyrene comprising about 70 to about 98 weight percent homopolystyrene, and about 2 to about 30 weight percent of rubber modifier that is a polymerization product of at least one C₄-C₁₀ nonaromatic diene monomer;
wherein the solvent comprises toluene;
wherein the anti-solvent comprises methanol;
wherein about 20 weight percent to 50 weight percent total of the poly(arylene ether) and the poly(alkenyl aromatic) are dissolved in the solution prior to forming the dispersion, wherein weight percents are based on a total weight of poly(arylene ether), poly(alkenyl aromatic), and solvent; and
wherein the solid comprises less than or equal to 5 weight percent of particles having a particle size less than 75 micrometers as determined according to ASTM D 1921-01, Method B.

17. A solid prepared according to the method of claim 1, wherein the solid comprises less than or equal to 15 weight percent of particles having a particle size less than 75 micrometers as determined according to ASTM D 1921-01, Method B.

18. A solid prepared according to the method of claim 13, wherein the solid comprises less than or equal to 5 weight percent of particles having a particle size less than 75 micrometers as determined according to ASTM D 1921-01, Method B.

19. A solid prepared according to the method of claim 16, wherein the solid comprises less than or equal to 2 weight percent of particles having a particle size less than 75 micrometers as determined according to ASTM D 1921-01, Method B.

20. A polymer blend comprising the solid of claim 19 and a polymer selected from impact-modified polystyrenes, atactic homopolystyrenes, syndiotactic polystyrenes, block copolymers of an alkenyl aromatic and a conjugated diene, hydrogenated block copolymers of an alkenyl aromatic and a conjugated diene, and combinations thereof.
